(19) United States
(12) Patent Application Publication
(10) Pub. No.: US 2018/0172975 A1
(43) Pub. Date: Jun. 21, 2018

(54) MICROSCOPE DEVICE, STORAGE MEDIUM AND OBSERVATION METHOD

(71) Applicant: OLYMPUS CORPORATION, Tokyo (JP)

(72) Inventor: Yosuke TANI, Tokyo (JP)

(73) Assignee: OLYMPUS CORPORATION, Tokyo (JP)

(21) Appl. No.: 15/822,959

(22) Filed: Nov. 27, 2017

(30) Foreign Application Priority Data
Dec. 21, 2016 (JP) 2016-247805

(51) Int. Cl. G02B 21/36; G06T 5/50

(52) U.S. Cl. CPC G02B 21/367; G06T 2207/20221; G06T 5/50

(57) ABSTRACT

A microscope device 10 includes a color camera 3 that obtains observation images of a sample, an image process device that performs a mapped image generation process of generating a mapped image by combining a plurality of observation images obtained by the color camera 3, and a determination device that performs a first determination process of determining whether or not to use the observation images for the mapped image generation process. The image process device generates a mapped image by combining the observation images, including an observation image determined to be used for the mapped image generation process in the first determination process, and refrains from using, for the mapped image generation process, an observation image determined to be not used for the mapped image generation process in the first determination process.

### CROSS REFERENCE TO RELATED APPLICATIONS

This application is based upon and claims the benefit of priority from prior Japanese Patent Application No. 2016-247805, filed Dec. 21, 2016, the entire contents of which are incorporated herein by this reference.

### BACKGROUND OF THE INVENTION

### Field of the Invention

The present invention is related to a microscope device, a storage medium and an observation method that generate a mapped image.

### Description of the Related Art

Conventionally, a technique of generating a large mapped image by combining a plurality of obtained images is known as an observation technique for microscopes (Japanese Laid-open Patent Publication No. 2011-186305 and Japanese Laid-open Patent Publication No. 2013-050594). Techniques such as these make it possible to generate an image of a region that is wider than the field of view of the objective provided to the microscope, realizing observations of characteristics of the sample within a wide scope.

Also, when parts of the regions of a mapped image have a problem in the image quality etc. due to focus shifts, it is desired that the problematic regions be replaced with an image obtained again so as to change the mapped image to an appropriate one. Japanese Laid-open Patent Publication No. 2013-050594 discloses a technique that replaces, with a different image, parts of images constituting connected image data from among pieces of connected image data, which is constituted by connecting a plurality of images.

### SUMMARY OF THE INVENTION

A microscope device according to one aspect of the present invention is a microscope device including an image pickup device that obtains observation images of a sample, an image process device that performs a mapped image generation process of generating a mapped image by combining the plurality of observation images obtained by the image pickup device and a determination device that performs a first determination process of determining whether or not to use the observation images for the mapped image generation process, wherein the image process device generates the mapped image by combining the observation images, including an observation image determined to be used for the mapped image generation process in the first determination process, and refrains from using, for the mapped image generation process, an observation image determined to be not used for the mapped image generation process in the first determination process.

A non-transitory storage medium according to one aspect of the present invention is a non-transitory storage medium having stored therein a program that causes a computer to execute a process of making an image pickup device, an image process device, and a determination device operate so that the image pickup device obtains observation images of a sample, the image process device performs a mapped image generation process of generating a mapped image by combining the plurality of observation images obtained by the image pickup device, and the determination device performs a first determination process of determining whether or not to use the observation images for the mapped image generation process, wherein the image process device generates the mapped image by combining the observation images, including an observation image determined to be used for the mapped image generation process in the first determination process, and refrains from using, for the mapped image generation process, an observation image determined to be not used for the mapped image generation process in the first determination process.

An observation method according to one aspect of the present invention is an observation method including obtaining observation images of a sample, performing a first determination process of determining whether or not to use the observation images for the mapped image generation process, in which the plurality of obtained observation images are combined so as to generate a mapped image, and generating the mapped image by combining the observation images, including an observation image determined to be used for the mapped image generation process in the first determination process, and refraining from using, for the mapped image generation process, an observation image determined to be not used for the mapped image generation process in the first determination process.

### BRIEF DESCRIPTION OF THE DRAWINGS

The present invention will be more apparent from the following detailed description when the accompanying drawings are referenced.

FIG. 1 illustrates a configuration of a microscope device according to the first embodiment;

FIG. 2 illustrates a configuration example of a control device;

FIG. 3 is a functional configuration diagram of a control device;

FIG. 4 illustrates a mapped image generated by a process of an image process device (image process unit);

FIG. 5 is a flowchart illustrating a process sequence in which a mapped image is generated;

FIG. 6 is a flowchart illustrating a process sequence of a mapped image generation process according to a variation example; and

FIG. 7 is a flowchart illustrating a process sequence of a mapped image generation process according to still another variation example.

### DESCRIPTION OF THE EMBODIMENTS

According to the method disclosed by Japanese Laid-open Patent Publication No. 2013-050594, images are replaced in accordance with a selection instruction from the user. This means that the user has to find problematic images from among pieces of the connected image data so as to make a determination to replace such images and to give instructions to do so, leading to heavy burdens on the user during the connecting of images (i.e., during the generation of a mapped image).

In view of the above situation, it is an object of the present invention to provide a technique of automatically generating an appropriate mapped image when generating a mapped image.

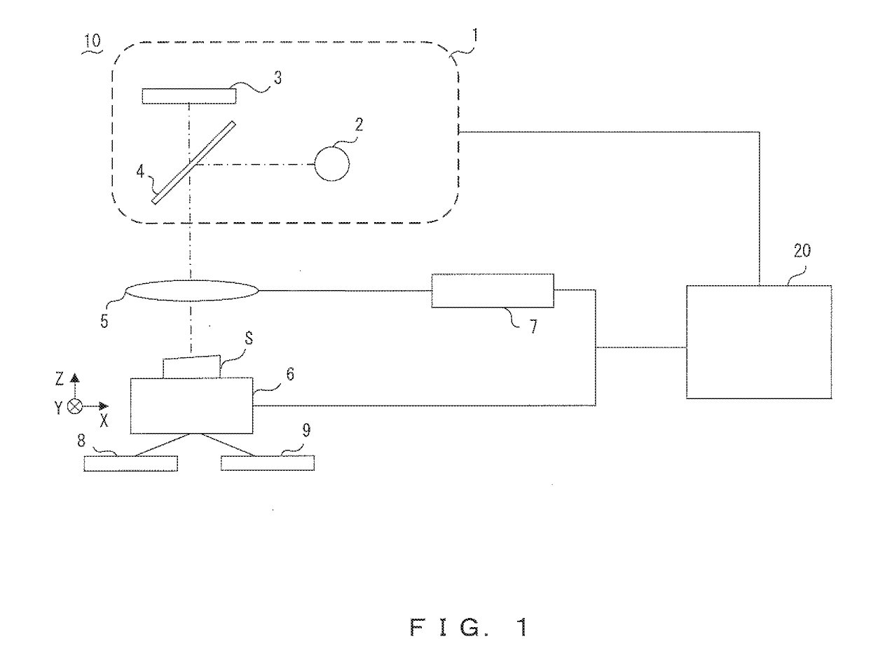

Hereinafter, explanations will be given for a microscope device 10 in the first embodiment of the present invention by referring to the drawings. FIG. 1 illustrates a configuration of the microscope device 10.

The microscope device 10 includes a color observation optical system 1, an objective 5, a stage 6 for mounting and fixing sample S, drive motors 7 and 8, a stage position detection mechanism 9 and a control device 20.

The color observation optical system 1 includes a white-light source 2, a color camera 3 and a half mirror 4. When the color observation optical system 1 is used for observations, illumination light issued from the white-light source 2 is reflected by the half mirror 4 and is cast on sample S via the objective 5. The light reflected by sample S passes through the same optical path as that of the illumination light and is detected by the color camera 3, and thereby a color bright-field-of-view observation image is obtained.

The color camera 3 is an image pickup device that detects the reflection light from sample S and obtains an observation image of sample S. A CCD camera, a CMOS image sensor, etc. may be used as the color camera 3.

The objective 5 is connected to the drive motor 7. The drive motor 7 operates under control of the control device 20 and changes the focal position of illumination light in the Z-axial directions by moving the objective 5 in the directions of the optical axis of the objective.

Also, the microscope device 10 may be provided with a revolver that includes a plurality of objectives and that can switch the objective 5 that is arranged in the optical path so as to be used from among the plurality of the objectives.

The stage 6 mounts and fixes sample S and is connected to the stage position detection mechanism 9 and the drive motor 8.

The drive motor 8 moves the stage 6 in the X, Y and Z directions, and thereby changes the cast position of the illumination light in the X, Y and Z directions. When an observation is performed by using the color observation optical system 1, the cast position of the illumination light can be changed through the movements of the stage 6 that are caused by the drive motor 8.

The stage position detection mechanism 9 detects the position information of sample S. The stage position detection mechanism 9 reads for example the value of the scale provided to the stage 6, on which sample S is set, and outputs that value to the control device 20 as its position information.

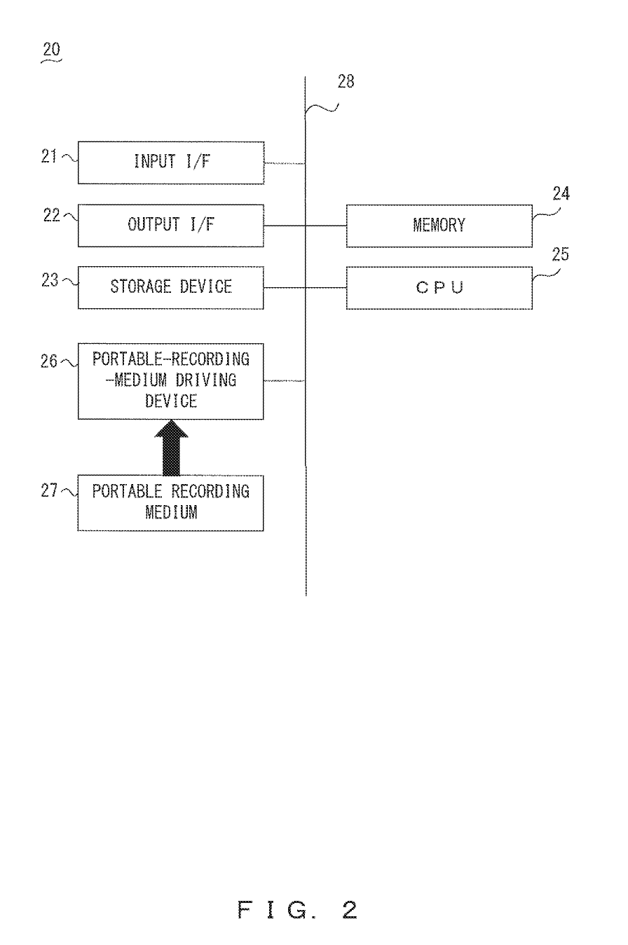

The control device 20 is a computer that controls respective constituents of the microscope device 10. FIG. 2 illustrates a configuration example of the control device 20.

The control device 20 includes for example an input interface (input I/F) 21, an output interface (output I/F) 22, a storage device 23, a memory 24, a CPU 25, and a portable-recording-medium driving device 26, and they are connected to each other via a bus 28.

The CPU 25 executes a program by using the memory 24. By the CPU 25 executing a program, the control device 20 functions as a control device that controls respective constituents of the microscope device 10. The memory 24 is for example a semiconductor memory such as a Read Only Memory (ROM), a Random Access Memory (RAM), etc. The storage device 23 is a non-transitory storage medium, and may be for example a magnetic disk device or a hard disk drive. Note that the storage device 23 may also be a tape device or may be a semiconductor memory such as a flash memory etc. The storage device 23 stores a program, observation image data, mapped image data, etc. A program, observation image data and mapped image data stored in the storage device 23 are loaded onto the memory 24 and are used.

The portable-recording-medium driving device 26 is a device that drives a portable recording medium 27, and accesses contents recorded in the portable recording medium 27. Examples of the portable recording medium 27 include non-transitory recording media such as a semiconductor device (USB memory etc.), a medium to/from which information is input or output through magnetic effects (such as a magnetic disk etc.), a medium to/from which information is input or output through optical effects (such as a CD-ROM, a DVD, etc.), etc. The portable recording medium 27 may store a program, observation image data, mapped image data, etc. A program, observation image data and mapped image data stored in the portable recording medium 27 may be loaded onto the memory 24 and used.

The output I/F 22 is an interface that outputs observation image data and mapped image data as an image signal to a display medium (not illustrated) such as a monitor device etc. The input I/F 21 is for example an interface that receives data from an input device (not illustrated) such as a keyboard, a mouse, etc., and receives inputs from the observer.

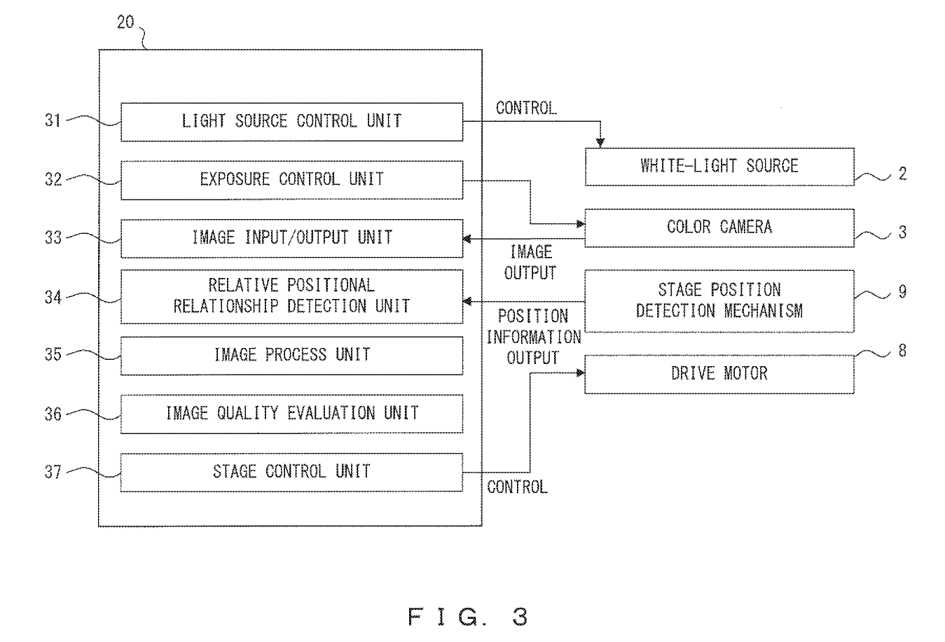

FIG. 3 is a functional configuration diagram of the control device 20. The control device 20 is a control device that controls respective constituents of the microscope device 10, and includes a light source control unit 31, an exposure control unit 32, an image input/output unit 33, a relative positional relationship detection unit 34, an image process unit 35, an image quality evaluation unit 36 and a stage control unit 37.

The light source control unit 31 performs ON/OFF controls for the white-light source 2. It may also control the switching etc. of the wavelengths of light used by the white-light source 2.

The exposure control unit 32 controls the exposures of the color camera 3. Specifically, through the control of the light source control unit 31 and the exposure control unit 32, an image of sample S is picked up by using the color observation optical system 1.

The image input/output unit 33 receives an image signal (which is observation image data of sample S) from the color camera 3, and outputs the image data to a display medium (not illustrated). Image data output from the image input/output unit 33 is a mapped image etc. generated by the image process unit 35, which will be described later.

The relative positional relationship detection unit 34 detects a relative positional relationship between sample S and the objective 5. A relative positional relationship is a relative position of sample S with respect to the objective 5, and is recorded as a position on a specified coordinate system (which will be referred to as an observation coordinate system). Note that while the observation coordinate system may include the coordinate information of each of the X, Y and Z directions, it is sufficient in this example if it includes the coordinate information of the X and Y directions. A relative positional relationship is determined by obtaining position information from the stage position detection mechanism 9. Also note that the control device 20, which functions as the relative positional relationship detection unit 34, will also be referred to as a relative positional relationship detection device.

Note that a relative positional relationship may be detected by treating a common characteristic in an overlapping region of two or more obtained observation images as a template and performing a pattern matching process in which the two or more observation images are arranged in an overlapping manner. Specifically, by arranging observation images having an overlapping portion on a virtual coordinate system in the control device 20 in such a manner that the templates coincide, the relative positional relationship of each of two observation images is understood.

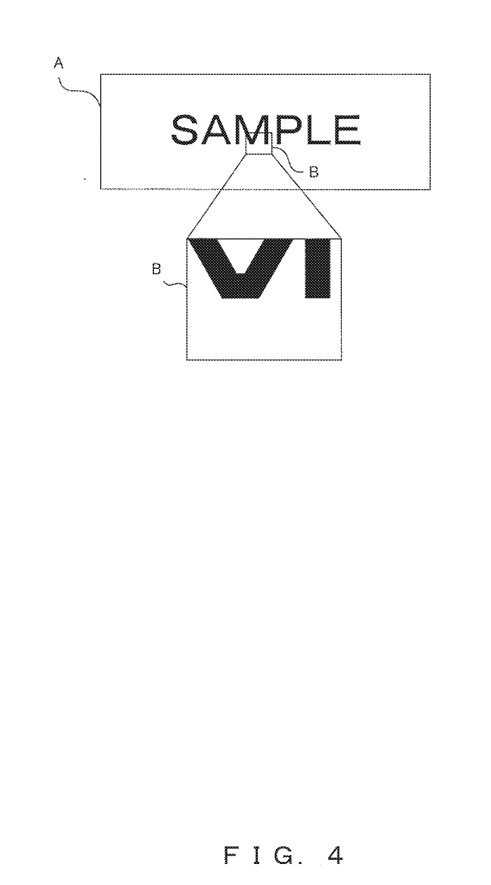

The image process unit 35 performs a mapped image generation process of generating a mapped image by combining a plurality of observation images obtained by the color camera 3, on the basis of the relative positional relationship. Note that the control device 20, which functions as the image process unit 35, will also be referred to as an image process device. FIG. 4 illustrates a mapped image generated by a process of the image process unit 35. Mapped image A is an image generated by combining a plurality of observation images B, which are observation images obtained within the scope of the field of view of the objective 5. Generating mapped image A like this makes it possible to provide the observer with an image that has information of sample S within a much wider scope than that of a single observation image B.

A mapped image as described above is generated on the basis of for example observation images, a relative positional relationship, and a relative relationship between the observation coordinate system, which is the coordinate system specifying the relative positional relationship, and the mapped image coordinate system. Generating a mapped image in the above manner will be referred to as a mapped image generation process or a generation process of a mapped image. A mapped image coordinate system is a coordinate system on which observation images are arranged when observation images are combined. A relative relationship associating the mapped image coordinate system and the observation coordinate system is stored in the control device 20 in advance. In other words, observation images obtained in respective relative positional relationships are arranged on the mapped image coordinate system on the basis of the relative relationships between the mapped image coordinate system and the observation coordinate system so as to generate one mapped image.

Also, when a relative positional relationship is detected by using a pattern matching process instead of the position information of the stage 8, a generation process of a mapped image is performed for example as below in the image process unit 36. For generating a mapped image, the observation image obtained first is arranged on the coordinate system of the mapped image. Thereafter, a plurality of observation images are obtained so that they have an overlapping region from which a template serving as a common characteristic is obtained and so that the observation images are arranged on the mapped image coordinate system by a pattern matching process, and thereby one mapped image is generated. In a generation process of a mapped image as described above, a relative positional relationship that determines the position of each observation image is detected in the course of arranging the observation images through a pattern matching process.

Also, relative positional relationships may be detected by combining the position information of the stage 8 and a pattern matching process. In such a case, the image process unit 36 detects relative positional relationships on the basis of the position information of the stage 8 detected by the stage position detection mechanism 16, and arranges, on the mapped image coordinate system, observation images obtained in respective relative positional relationships, on the basis of the relative relationship between the mapped image coordinate system and the observation coordinate system. Thereafter, the image process unit 36 further performs a pattern matching process on a plurality of observation images arranged on the mapped image coordinate system (i.e., observation images constituting the mapped image) so as to correct the relative positional relationships of the plurality of observation images. By arranging observation images on the mapped image coordinate system on the basis of the position information of the stage 8 as described above and thereafter performing a pattern matching process, it becomes possible to generate a more reliable mapped image in which positional shifts etc. between observation images are corrected.

Also, in a mapped image generation process performed in the present embodiment, in a relative positional relationship corresponding to observation images (which will also be referred to as second observation images) already arranged on the mapped image coordinate system, after newly obtaining observation images, a mapped image generation process is performed by using those obtained observation images. In other words, the image process unit 35 performs a process in which in a mapped image coordinate system on which observation images have once been arranged, new observation images obtained in the same relative positional relationship to the observation images that have already been arranged (second observation images) are replaced with the observation images that have already been arranged (second observation images). Hereinafter, replacing newly obtained observation images with second observation images so as to arrange them will also be referred to as updating second observation images with newly obtained observation images. Specifically, in a mapped image generation process performed by the image process unit 35, the execution of the two following mapped image generation patterns is assumed. The first is the first mapped image generation pattern in which in a state in which a second observation image is not arranged at a position on the mapped image coordinate system, the position corresponding to the relative positional relationship of the observation image obtained by the color camera 3, an obtained observation image is arranged on a mapped image coordinate system. The second is the second mapped image generation pattern in which in a state in which a second observation image is arranged at a position on the mapped image coordinate system, the position corresponding to the relative positional relationship of an observation image obtained by the color camera 3, a second observation image is updated with an obtained observation image.

The image quality evaluation unit 36 performs the first determination process in which it is determined whether or not to use an observation image obtained by the color camera 3 for the above mapped image generation process performed by the image process unit 35. In this example, the first determination process is performed for each observation image obtained within the scope of the field of view of the objective 5. Note that the control device 20 functioning as the image quality evaluation unit 36 may also be referred to as a determination device.

Observation images obtained by the color camera 3, including observation images determined to be used for the mapped image generation process in the first determination process performed by the image quality evaluation unit 36, are used by the image process unit 35 for the mapped image generation process. In other words, the image process unit 35 generates a mapped image by combining those observation images. Meanwhile, observation images determined not to be used for the mapped image generation process in the first determination process are not used for a mapped image generation process that is performed by the image process unit 35.

In the above second mapped image generation pattern, it is assumed that when an observation image is determined to be used in a mapped image generation process as a result of the first determination process, a second observation image arranged at a position corresponding to the relative positional relationship of an observation image is updated with a newly obtained observation image.

Also, the first determination process is performed on the basis of the determination result of the second determination process or the third determination process performed by the image quality evaluation unit 36. Hereinafter, explanations will be given for the second determination process and the third determination process.

The second determination process is a determination process that evaluates the image quality of an observation image. The evaluation of an image quality referred to in this example is performed by using the contrast value of an observation image. A contract value is a value obtained by calculating the difference in brightness value with respect to an adjacent pixel for each pixel in an observation image and totaling the calculated differences. An adjacent pixel may be a pixel existing in vertical, horizontal or diagonal directions of a particular pixel. Alternatively, it may be pixels existing in vertical, horizontal and diagonal directions. Also, a brightness value of a particular color component (for example the R component of RGB) in an image may be used, and a brightness value in an image converted into a gray scale may be used. In the second determination process, the contrast value of an observation image is first calculated.

Then, in the second determination process, the image quality is evaluated by determining whether or not the contrast value of the observation image is equal to or greater than a particular set value. As a general rule, contrast values of images that are in focus tend to be higher than contrast values of images that are out of focus. Accordingly, image quality evaluation can be performed on the basis of contrast values by setting a particular set value as a threshold between a contrast value range in which the images are determined to be in focus and to lead to good image quality and a contrast value range in which the images are determined to be out of focus and to lead to problematic image quality. A value set by the user or set arbitrarily in advance is stored in the control device 20 as a set value.

Because the image quality of an observation image is good when the contrast value is determined to be equal to or greater than a set value in the second determination process, the image is determined to be an image used for a mapped image generation process in the first determination process. When by contrast the contrast value is determined to be equal to or lower than a set value in the second determination process, the image quality of the observation image has a problem, and thus the image is determined to be an image that is not to be used for a mapped image generation process in the first determination process.

Also, in the present embodiment, it is assumed that the second determination process is performed for obtained observation images when the obtained observation images are to be arranged on a mapped image coordinate system (first mapped image generation pattern) in a state in which a second observation image is not arranged at a position on the mapped image coordinate system, the position corresponding to the relative positional relationship of the obtained observation images. Note that while the second determination process may be performed when updating is performed by using obtained observation images (second mapped image generation pattern), it will be explained as a variation example of the present embodiment, which will be explained later.

The third determination process is a process performed when second observation images are updated with obtained observation images (second mapped image generation pattern), in a state in which a second observation image is arranged at a position on the mapped image coordinate system, the position corresponding to the relative positional relationship of the observation image obtained by the color camera 3. In the third determination process, observation images obtained by the color camera 3 and a second observation image that has already been arranged on the mapped image coordinate system are each evaluated and compared.

Image quality evaluation in the third determination process is performed by using the contrast value of an observation image. In image quality evaluation performed in the third determination process, the contrast value of an observation image and the contrast value of the second observation image that has already been arranged on the mapped image coordinate system are calculated. Calculations of contrast values are performed in a manner similar to the method explained for the second determination process.

Then, in the third determination process, an observation image and a second observation image are compared. More specifically, in the third determination process, comparison is performed between the contrast value calculated for the observation image and the contrast value calculated for the second observation image, and it is determined which of the images has the higher contrast value than the other.

When it is determined that the contrast value of a newly obtained observation image is higher than the contrast value of the second observation image in the third determination process, it is determined to be an image used for the mapped image generation process in the first determination process. This is because the image quality of a newly obtained observation image is an image having a higher quality than that of a second observation image that has already been arranged. In other words, in such a case, the image process unit 35 updates, with a newly obtained observation image, a second observation image arranged at a position on the mapped image coordinate system, the position corresponding to the relative positional relationship of a newly obtained observation image. When, by contrast, the contrast value of a newly obtained observation image is determined in the third determination process to be smaller than the contrast value of a second observation image, it is determined to be an image not used for the mapped image generation process in the first determination process. This is because a second observation image that has already been arranged is an image having a higher image quality than that of a newly obtained observation image. In other words, a second observation image that has already been arranged is not updated with a newly obtained observation image, and remains in a state in which it has been arranged.

As described above, the image quality evaluation unit 36 performs the second determination process when a second observation image has not been arranged at a position on the mapped image coordinate system, the position corresponding to the relative positional relationship of an observation image obtained by the color camera 3. Also, when a second observation image has been arranged at a position on the mapped image coordinate system, the position corresponding to the relative positional relationship of an observation image obtained by the color camera 3, the image quality evaluation unit 36 functions so that the third determination process is performed.

Performing the second determination process prevents an image of a contrast value that is smaller than a set value from being used for a mapped image generation process, guaranteeing by the contrast value the image quality of an observation image used for a mapped image.

By performing the third determination process, when an observation image having a higher image quality than that of an observation image that has already been arranged on the mapped image coordinate system is obtained, that observation image replaces the already arranged observation image, making it possible to further improve the image quality of the mapped image.

In particular, when a mapped image is to be updated with a newly obtained observation image, even when a newly obtained observation image has a poorer image quality (being out of focus etc.) than that of an observation image that has already been arranged, the third determination process is performed, making it possible to prevent the mapped image from being updated with an observation image having a poor image quality.

The stage control unit 37 is a unit that scans illumination light in a state in which observation images are being obtained by using the color observation optical system 1. The stage control unit 37 controls the drive motor 9.

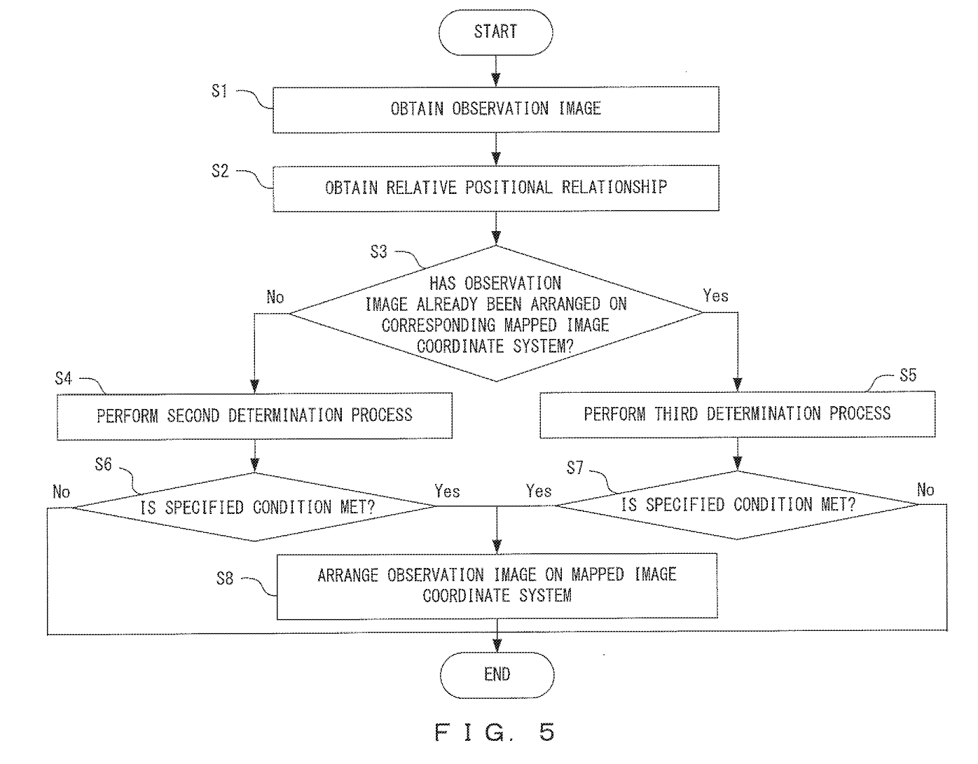

By referring to the flowcharts, explanations will be given for a process sequence of generating a mapped image by using the microscope device 10 having the above configuration. FIG. 5 is a flowchart illustrating a process sequence in which the control device 20 in the microscope device 10 generates a mapped image. The process in FIG. 5 is started after the control device 20 receives an instruction from the observer to start the generation of a mapped image.

In step S1, the exposure control unit 32 starts the exposure of the color camera 3 and an observation image is obtained.

In step S2, the relative positional relationship detection unit 34 detects a relative positional relationship by using position information corresponding to the observation image obtained in step S1 (position information obtained from the stage position detection mechanism 9).

In step S3, on the basis of the relative relationship between the observation coordinate system and the mapped image coordinate system, the image quality evaluation unit 36 determines whether or not an observation image (second observation image) has already been arranged at a position on the mapped image coordinate system, the position corresponding to the relative positional relationship obtained in step S2. When the determination result is NO in step S3, i.e., when a second observation image has not been arranged, the process proceeds to the process in step S4. When the determination result is YES in step S3, i.e., when a second observation image has been arranged, the process proceeds to the process in step S5.

In step S4, the image quality evaluation unit 36 performs the second determination process. In other words, the image quality evaluation unit 36 calculates the contrast value of an observation image and determines whether or not the contrast value of the observation image is equal to or greater than a particular set value, thereby evaluating the image quality. The specified condition is determined to be met in step S6 when the result of the determination in step S4 is that the contrast value of the observation image is equal to or greater than a particular set value, and the process proceeds to step S8. When the contrast value of the observation image is smaller than a particular set value in step S6, the specified condition is determined not to be met, and the process of this flowchart is terminated without using the observation image obtained in step S1 for the generation of a mapped image.

In step S8, the image process unit 35 arranges the observation image obtained in step S1 on the mapped image coordinate system on the basis of the relative positional relationship obtained in step S2.

Explanations will now be given for a state in which the determination result is YES in step S3 and the process has proceeded to step S5. In step S5, the image quality evaluation unit 36 performs the third determination process. In other words, the image quality evaluation unit 36 calculates the contrast values respectively of the observation image obtained in step S1 and the second observation image, and compares the respective contrast values. When the result of the determination in step S5 is that the contrast value of the observation image is greater than the contrast value of the second observation image, the specified condition is determined to be met in step S7, and the process proceeds step S8. When the contrast value of the observation image is smaller than the contrast value of the second observation image in step S7, the specified condition is determined not to be met, and the process of this flowchart is terminated without using the observation image obtained in step S1 for the generation of a mapped image.

The microscope device 10 described above makes it possible to automatically generate an appropriate mapped image when a mapped image is generated. In the present configuration particularly, an appropriate mapped image having no problem in the image quality can automatically be generated when the user just inputs to the control device 20 an instruction to perform a mapped image generation process on an observation coordinate system on which they want to obtain a mapped image, making it possible to greatly reduce manipulation burdens on users accompanying the generation of the mapped image.

Also, when the objective 5 that is used for generating a mapped image is changed by using a revolver etc., an observation image having a problem in the image quality is likely to be obtained with a contrast that is lower than before the change of the objective, particularly when the objective is changed to one with a high magnification. Even when the objective is changed for generating a mapped image, the present invention performs the first determination process on the basis of the determination results of the second and third determination processes and thereby can prevent the mapped image from being generated or updated by using observation images having a problem in the image quality, which can be obtained accompanying the change of the objective.

Hereinafter, explanations will be given for a variation example of a process performed in the determination device of the first embodiment (the control device 20 that functions as the image quality evaluation unit 36). While the image quality evaluation unit 36 according to the first embodiment performs the second determination process when a second observation image has not been arranged at a position on the mapped image coordinate system, the position corresponding to the relative positional relationship of the observation image obtained by the color camera 3, and performs the third determination process when a second observation image has been arranged at a position on the mapped image coordinate system, the position corresponding to the relative positional relationship of the observation image obtained by the color camera 3, the process of the image quality evaluation unit 36 is not limited to this.

In the present variation example, the image quality evaluation unit 36 does not perform the third determination process, and performs the second determination process regardless of whether or not the second observation image has already been arranged.

In such a case, in a state in which a second observation image is arranged at a position on the mapped image coordinate system, the position corresponding to the relative positional relationship of an observation image obtained by the color camera 3, the image quality evaluation unit 36 evaluates the image quality of the obtained observation image. Also, when the obtained observation image has a contrast value that is equal to or greater than a set value, the second observation image is updated with the obtained observation image. Note that in the process performed in a state in which a second observation image is not arranged at a position on the mapped image coordinate system, the position corresponding to the relative positional relationship of an observation image obtained by the color camera 3, the second determination process is performed similarly to the first embodiment.

As described above, even when the image quality evaluation unit 36 functions so that it performs the first determination process on the basis only of the determination result of the second determination process, an appropriate mapped image can automatically be generated when generating a mapped image.

Also, as a set value used for the second determination process, different set values that are different between a state in which the second observation image is arranged and a state in which a second observation image is not arranged may be used. For example, a set value used for a state in which a second observation image is arranged may be set to be equal to a contrast value that is higher than a set value used in a state in which a second observation image is not arranged. In other words, a region in which second observation images have been arranged is updated with observation images having a higher image quality, making it possible to avoid unnecessary updates with observation images having image qualities that are not greatly different from those of second observation images that have been arranged.

Also, while the first determination process is performed for each observation image obtained within the scope of the field of view of the objective 5 in the first embodiment, the scope is not limited to this. In the present variation example for example, the first determination process may be performed for each observation image that results from further dividing an observation image obtained within the scope of the field of view of the objective 5 into a plurality of regions. The size of divisional regions may be in units of pixels, and it is also possible to determine the contrast value for each pixel (second determination process), to perform replacement with a second observation image arranged on the mapped image coordinate system for each pixel, and to perform the arrangement. This configuration performs the second determination process in smaller units in the mapped image, making it possible to further improve the image quality.

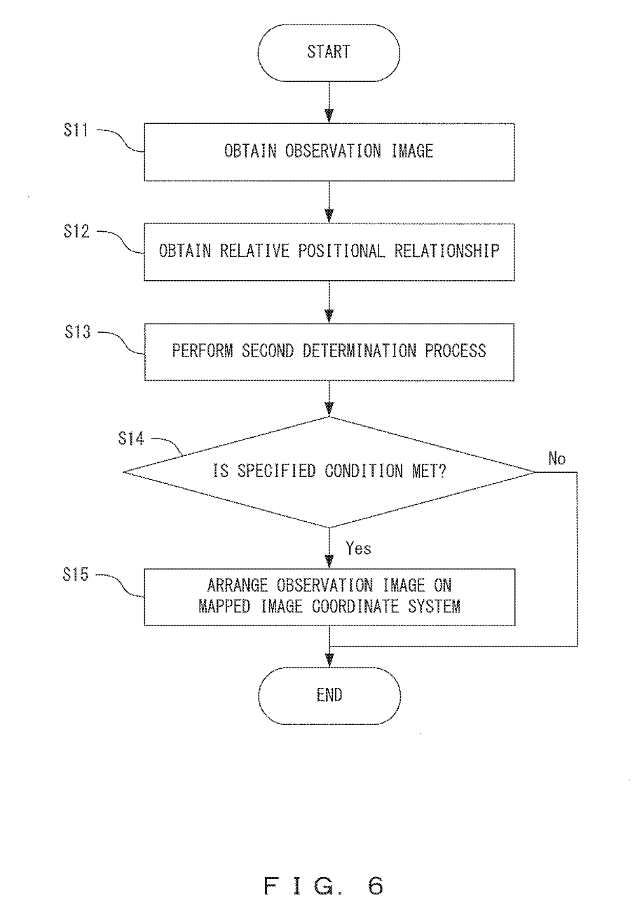

By referring to the flowcharts, explanations will be given for a process sequence of generating a mapped image in the above variation example. FIG. 6 is a flowchart illustrating a process sequence of a mapped image generation process according to a variation example. The process in FIG. 6 is started after the control device 20 receives an instruction from the observer to start the generation of a mapped image.

Step S11 and step S12 are similar to step S1 and step S2 in the flowchart of FIG. 5. When an observation image and a relative positional relationship corresponding to that observation image are obtained in step S11 and step S12, the process proceeds to step S13.

In step S13, the image quality evaluation unit 36 performs the second determination process. In other words, the image quality evaluation unit 36 calculates the contrast value of an observation image and determines whether or not the contrast value of the observation image is equal to or greater than a particular set value, and thereby evaluates the image quality.

The specified condition is determined to be met in step S14 when the result of the determination in step S13 is that the contrast value of the observation image is equal to or greater than a particular set value, and the process proceeds to step S15. When the contrast value of the observation image is smaller than a particular set value in step S14, the specified condition is determined not to be met, and the process of this flowchart is terminated without using the observation image obtained in step S11 for the generation of a mapped image.

In step S15, the image process unit 35 arranges an observation image obtained in step S1 on the mapped image coordinate system on the basis of the relative positional relationship obtained in step S2.

Hereinafter, explanations will be further given for another variation example of a process performed in the control device 20 that functions as the determination device of the first embodiment (the control device 20 that functions as the image quality evaluation unit 36). In the present variation example, the image quality evaluation unit 36 does not perform the second determination process. More specifically, in a state in which a second observation image is not arranged at a position on the mapped image coordinate system, the position corresponding to the relative positional relationship of an observation image obtained by the color camera 3, when the obtained observation image is arranged on the mapped image coordinate system (first mapped image generation pattern), a determination process is not performed by the image quality evaluation unit 36. Also, the image process unit 35 is different from that in the process in the first embodiment in that it unconditionally arranges observation images obtained by the color camera 3 on the mapped image coordinate system. Note that in a state in which a second observation image is arranged at a position on the mapped image coordinate system, the position corresponding to the relative positional relationship of the observation image obtained by the color camera 3, for a case when the obtained observation image is arranged on the mapped image coordinate system (second mapped image generation pattern), the third determination process is performed similarly to the first embodiment.

As described above, even when the image quality evaluation unit 36 functions so that it performs the first determination process on the basis only of the determination result of the third determination process, an appropriate mapped image can automatically be generated when generating a mapped image.

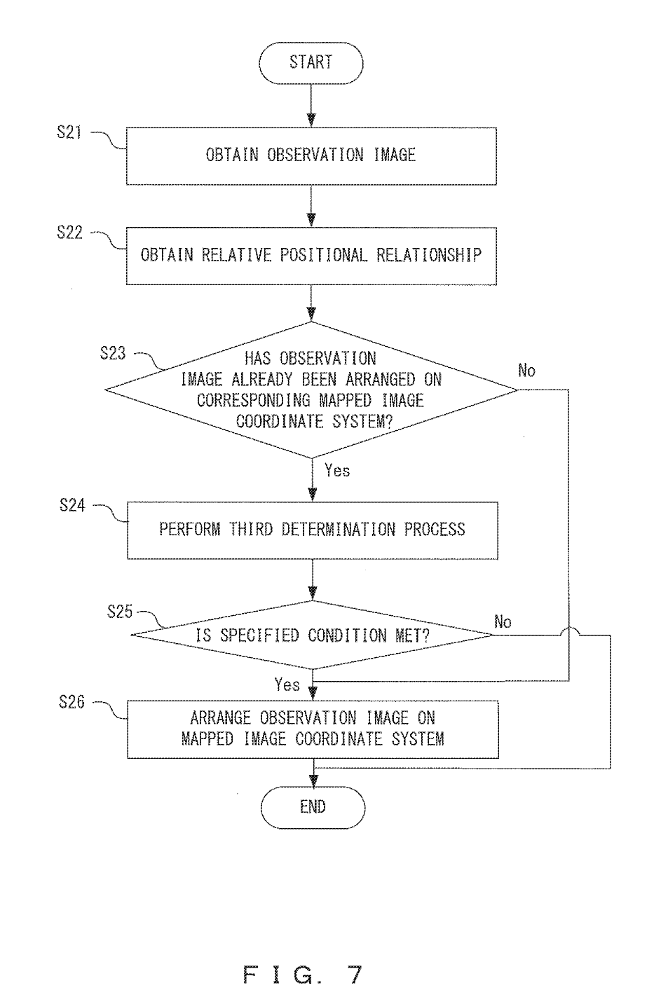

By referring to the flowcharts, explanations will be given for a process sequence of generating a mapped image in the above variation example. FIG. 7 is a flowchart illustrating a process sequence of a mapped image generation process in the present variation example. The process in FIG. 7 is started after the control device 20 receives an instruction from the observer to start the generation of a mapped image.

Step S21 and step S22 are similar to step S1 and S2 in the flowchart of FIG. 5. When an observation image and a relative positional relationship corresponding to that observation image are obtained in step S21 and step S22, the process proceeds to step S23.

In step S23, the image quality evaluation unit 36 determines whether or not an observation image (second observation image) has already been arranged at a position on the mapped image coordinate system, the position corresponding to the relative positional relationship obtained in step S22, on the basis of the relative relationship between the observation coordinate system and the mapped image coordinate system. When the determination result is NO in step S23, i.e., when a second observation image has not been arranged, the process proceeds to step S26, and an observation image obtained in step S21 is arranged on the mapped image coordinate system on the basis of the relative positional relationship obtained in step S22. Also, when the determination result is YES in step S23, i.e., when a second observation image has been arranged, the process proceeds to the process in step S24.

The processes in step S24 and step S25 are similar to those in step S5 and step S7.

As described above, the present invention makes it possible to automatically generate an appropriate mapped image when generating a mapped image.

The above described embodiments are specific examples for facilitating understanding of the invention and the present invention is not limited to these embodiments. The above microscope devices, storage media and observation methods can receive various modifications and changes without departing from the present invention described in the claims.

What is claimed is:

1. A microscope device comprising:
an image pickup device that obtains observation images of a sample;
an image process device that performs a mapped image generation process of generating a mapped image by combining the plurality of observation images obtained by the image pickup device; and
a determination device that performs a first determination process of determining whether or not to use the observation images for the mapped image generation process, wherein
the image process device generates the mapped image by combining the observation images, including an observation image determined to be used for the mapped image generation process in the first determination process, and refrains from using, for the mapped image generation process, an observation image determined to be not used for the mapped image generation process in the first determination process.

2. The microscope device according to claim 1, wherein
the determination device performs the first determination process on the basis of a result of a second determination process, which evaluates image quality of the observation image.

3. The microscope device according to claim 2, further comprising
an objective, and
a relative positional relationship detection device that detects a relative positional relationship between the sample and the objective, wherein
the image process device performs the mapped image generation process by arranging the observation images on a mapped image coordinate system on the basis of the relative positional relationship and a relative relationship between an observation coordinate system, which is a coordinate system specifying the relative positional relationship, and the mapped image coordinate system.

4. The microscope device according to claim 3, wherein
the image process device updates a second observation image arranged at a position on the mapped image coordinate system, the position corresponding to the relative positional relationship of the observation image with the observation image, when the observation image is determined to be used for the mapped image generation process as a result of the first determination process by the determination device in a case when the second observation image has been arranged at a position on the mapped image coordinate system, the position corresponding to the relative positional relationship of the observation image obtained by the image pickup device.

5. The microscope device according to claim 4, wherein
the determination device performs a third determination process that performs image quality evaluation respectively on the observation image obtained by the image pickup device and the second observation image and comparison of those, and performs the first determination process on the basis of a result of the third determination process.

6. The microscope device according to claim 5, wherein
the determination device
performs the second determination process in a case when the second observation image has not been arranged at a position on the mapped image coordinate system, the position corresponding to the relative positional relationship of the observation image obtained by the image pickup device, and
performs the third determination process in a case when the second observation image has been arranged at a position on the mapped image coordinate system, the position corresponding to the relative positional relationship of the observation image obtained by the image pickup device.

7. The microscope device according to claim 3, wherein
the first determination process is performed for each of the observation images obtained within a scope of a field of view of the objective.

8. The microscope device according to claim 3, wherein
the first determination process is performed for each observation image obtained by further dividing, into a plurality of regions, the observation image obtained within a scope of a field of view of the objective.

9. The microscope device according to claim 2, wherein
the determination device performs the image quality evaluation of the observation image in the second determination process by using a contrast value.

10. The microscope device according to claim 5, wherein
the determination device performs the image quality evaluation of the observation image in the third determination process by using a contrast value.

11. A non-transitory storage medium having stored therein a program that causes a computer to execute a process of making an image pickup device, an image process device, and a determination device operate so that
the image pickup device obtains observation images of a sample,
the image process device performs a mapped image generation process of generating a mapped image by combining the plurality of observation images obtained by the image pickup device, and
the determination device performs a first determination process of determining whether or not to use the observation images for the mapped image generation process, wherein
the image process device generates the mapped image by combining the observation images, including an observation image determined to be used for the mapped image generation process in the first determination process, and refrains from using, for the mapped image generation process, an observation image determined to be not used for the mapped image generation process in the first determination process.

12. An observation method comprising:
obtaining observation images of a sample;
performing a first determination process of determining whether or not to use the observation images for the mapped image generation process, in which the plurality of obtained observation images are combined so as to generate a mapped image; and
generating the mapped image by combining the observation images, including an observation image determined to be used for the mapped image generation process in the first determination process, and refraining from using, for the mapped image generation process, an observation image determined to be not used for the mapped image generation process in the first determination process.
